(19) United States
(12) Patent Application Publication
(10) Pub. No.: US 2006/0181752 A1
(43) Pub. Date: Aug. 17, 2006

(54) Elastic device for a scanning device

(75) Inventor: Yulun Chang, Miaoli County (TW)

Correspondence Address: CHARLES E. BAXLEY, ESQ., 90 JOHN STREET, THIRD FLOOR, NEW YORK, NY, 10038, US

(73) Assignee: Avision Inc.

(21) Appl. No.: 11/230,133

(22) Filed: Sep. 19, 2005

(30) Foreign Application Priority Data
Sep. 21, 2004 (TW) 093128504

(51) Int. Cl. G02B 26/08

(52) U.S. Cl. 359/197

(57) ABSTRACT

An elastic device is joined with a transmission system of a scanning device. The elastic device comprises a displacement component, a fixing component, and an elastic component. The fixing component mounted on the casing of the scanning device and combined with the displacement component. The elastic component disposed between the fixing component and displacement, wherein the elastic component connected to the fixing component at one end and connected to the displacement at another end. The displacement component joining with a belt of the transmission system, wherein the displacement component moves relatively to the fixing component when said transmission belt exerts a force on said displacement component. The combination of the fixing component and the displacement component restricts a moving distance of the displacement component with respect to said fixing component.

### BACKGROUND OF THE INVENTION

1. Field of the Invention

The present invention relates generally to an elastic device, and more particularly to an elastic device constructed, such that when the elastic device is used for a transmission system of a scanner or a scanning unit of a multi-function peripheral, the transmission belt of the transmission system can transport a movable scanning module of the scanner more accurately and efficiently.

2. Description of the Prior Art

A conventional scanning device or a multi-function peripheral comprises a casing and an optic-module device, and a transmission system in the casing. The transmission system has a transmission belt that is joined with and provides power for the optic-module device to move reciprocatingly.

One end of the transmission belt is connected to one end of a spring, while the other end of the spring is affixed to the casing. With this structure, the spring deforms under force and then is capable of providing a restoring force on the transmission belt, so that the transmission belt produces constant tension and, thus, drives the optic-module device to move.

However, since one end of the spring connects to the transmission belt and the other end of the spring is fixed on the casing, the spring may be extended or be compressed beyond its functional limit when loaded with the driving force of the transmission belt. In this circumstance, the spring may become permanently deformed when overloaded and therefore unable to recover to its normal state. As a result, the spring and transmission belt are not capable of providing constant tension for the transmission belt to drive the optic-module device.

### SUMMARY OF THE INVENTION

The present invention is an elastic device which joins with a transmission belt of a transmission system of a scanning device so that the tension of the transmission belt is stable by the elastic device, and the scanning module of the scanning device can move smoothly.

The primary objective of the present invention is to restrict the maximum deformation of the elastic component (i.e. the spring) in the elastic device and, thus, protect the spring component from fatigue and ensure consistent tension of the transmission belt.

To achieve this objective, the prevent invention utilizes the following components and techniques:
A fixing component mounted firmly on a surface of said casing.
A displacement component joined with the transmission belt, wherein the displacement component moves relatively to the fixing component when the transmission belt exerts a force on the displacement component.
An elastic component disposed between the fixing component and displacement component.

The combination of the fixing component and the displacement component restricts a moving distance of the displacement component, with respect to the fixing component, within a maximum value, the maximum value being less than the maximum extension/compression length of the elastic component, so the elastic component is protected from over-deformation and stable tension of the transmission belt is thus ensured.

The displacement and fixing components of the present invention are connected respectively to each end of the elastic component, and the range of the relative displacement distance between the displacement and fixing components is fixed to restrict the maximum displacement of the displacement and elastic components when both are pulled under spring force. As a result, the maximum displacement will not exceed the elastic limit of the elastic component, thus ensuring the provision of stable and appropriate tension for the transmission belt to drive the scanning device.

### BRIEF DESCRIPTION OF THE DRAWINGS

FIG. 1 is a schematic view showing an overhead layout plan of the present invention mounted on a scanning device;

FIG. 2 is an appearance view of a first embodiment of the present invention;

FIG. 3 is a schematic view showing a cross-sectional structure of the first embodiment of the present invention;

FIG. 4 is a schematic view showing that an elastic component of the first embodiment of the present invention is loaded with and pulled by a pulling force;

FIG. 6 is an appearance view of a second embodiment of the present invention;

FIG. 7 is a schematic view showing a cross-sectional structure of the second embodiment of the present invention; and

FIG. 8 is a schematic view showing that an elastic component of the second embodiment of the present invention is loaded with and pulled by a pulling force.

### DETAILED DESCRIPTION OF THE INVENTION

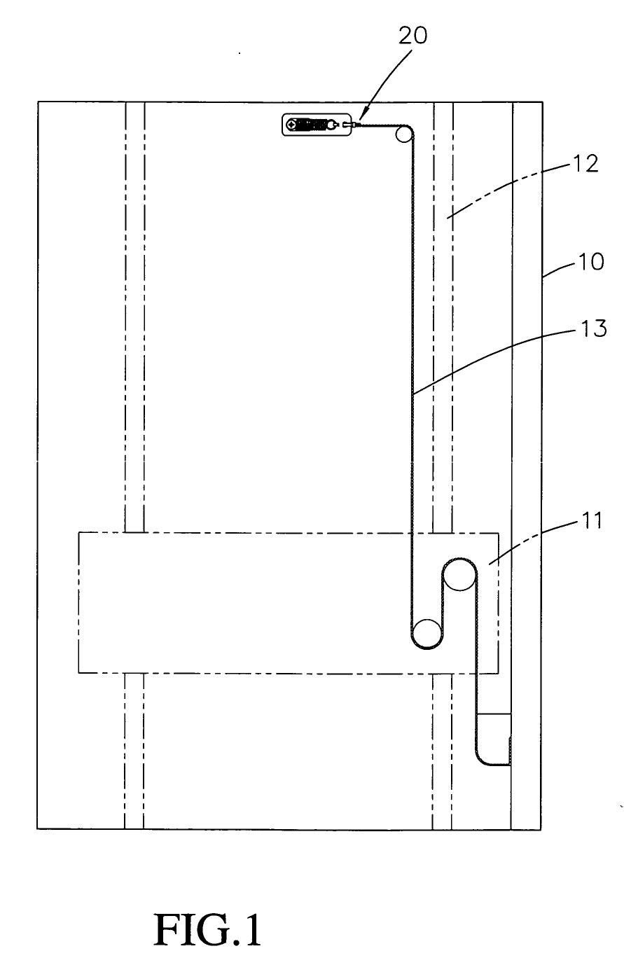

The present invention provides an elastic device. As shown in FIG. 1, a scanning device comprises a casing 10, i.e. the lower casing of the scanning device. A scanning module 11 is disposed in the casing 10. At least one guide rod 12 is disposed on an inner wall opposite the casing 10 which extends through the scanning module 11 so that the scanning module 11 is capable of moving axially along the guide rod 12.

A transmission belt 13 is disposed on the bottom of the scanning module 11. One end of the transmission belt 13 is fixed on the casing 10 and the other end of the transmission belt 13 is connected to an elastic device 20. The transmission belt 13 is a component of a transmission system, which drives the transmission belt 13 which, in turn, drives the scanning module 11 in reciprocating motion.

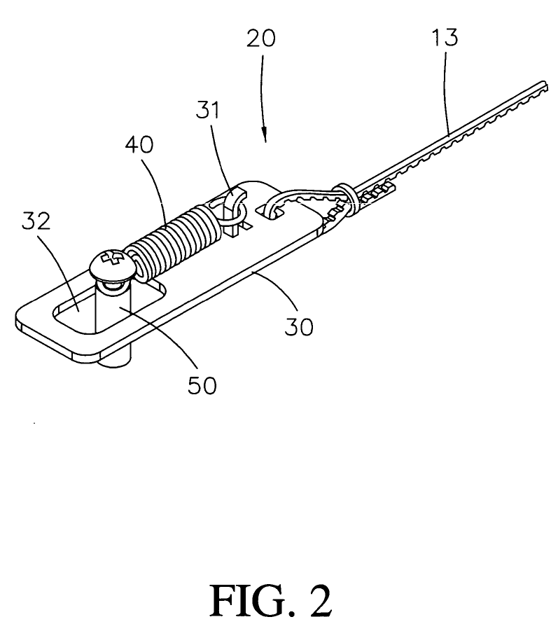

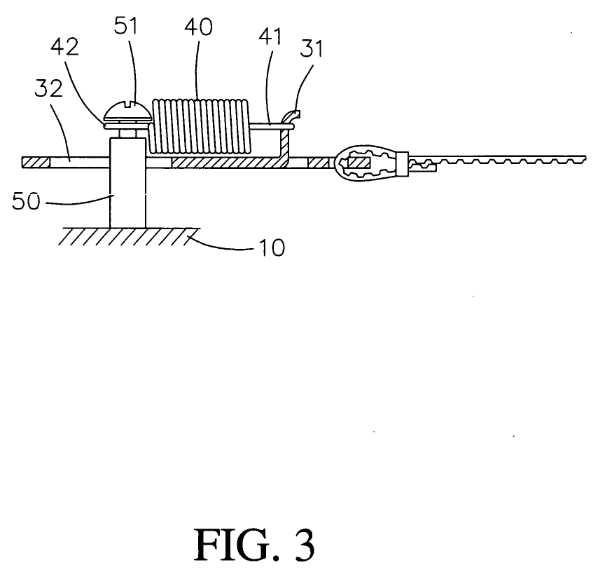

As shown in FIGS. 2 and 3, the elastic device 20 includes a displacement component 30, a fixing component 50, and an elastic component 40. The displacement component 30 is a longitude plate comprising a hook piece 31 on the surface thereof and a stroke hole 32. The hook piece 31 protrudes from the surface of the displacement component 30 and the stroke hole 32 is designed in a longitude form, wherein the hook piece 31 keeps a certain distance from the stroke hole 32. Moreover one end of the displacement component 30 that is away from the stroke hole 32 is connected to the transmission belt 13.

Tne fixing component 50 is a column mounted vertically on the bottom surface of the casing 10. The fixing component 50 is fixed on the casing 10 so that it is disposed inside the stroke hole 32 of the displacement component 30, which is aligned for insertion. As a result, the relative displacement between the displacement component 30 and the fixing component 50 is restricted within the length of the stroke hole 32.

The preferred embodiment of the elastic component 40 is a spring or other elastic material. The elastic component 40 has a first end 41 and a second end 42. The first end 41 is connected to the hook piece 31 on the displacement component 30, and the second end 42 is connected to the fixing component 50. The second end 42 can be screwed on the fixing component 50 with a screw 51 to make the elastic component 40 extend and contract elastically in parallel to the stroke hole 32.

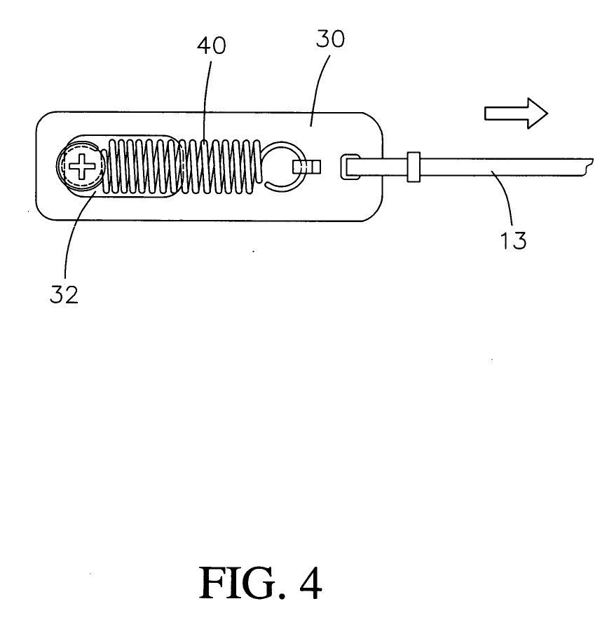

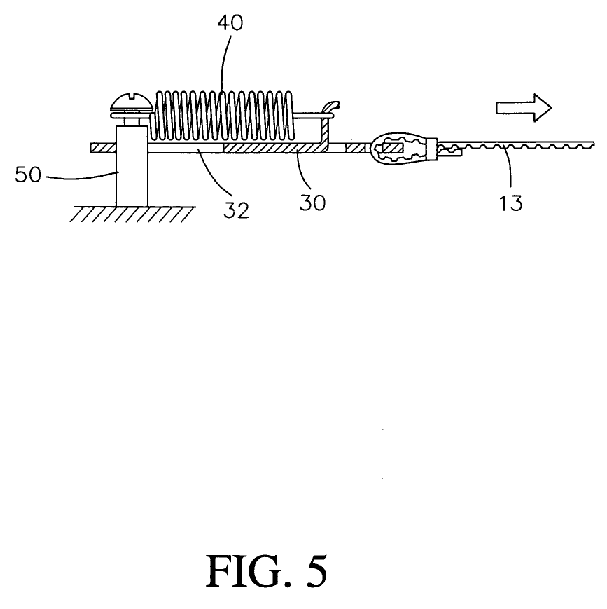

As shown in FIG. 1, the tension of the transmission belt 13 increases when the transmission belt 13 pulls the scanning module 11, or when the transmission belt 13 and the elastic device 20 are assembled. In these circumstances, the transmission belt 13 pulls the displacement component 30 and, as a result, makes the elastic component 40 extend as shown in FIGS. 4 and 5.

This mechanism results in the displacement component 30 and the elastic component 40 being pulled simultaneously. As a result, the displacement component 30 cannot move, and the elastic component 40 cannot extend any further once the displacement component 30 moves against the fixing component 50 so that the edge of the displacement hole 32 touches the fixing component 50.

Therefore, the displacement constraining function provided by the fixing component 50 and the stroke hole 32 of the displacement component 30 ensures that the maximum extension of the elastic component 40 is restricted within the elastic limit thereof and no permanent deformation of the elastic component 40 is caused. This mechanism ensures constant tension of the transmission belt 13, which, in turn, drives the scanning module 11 in a smooth and steady motion.

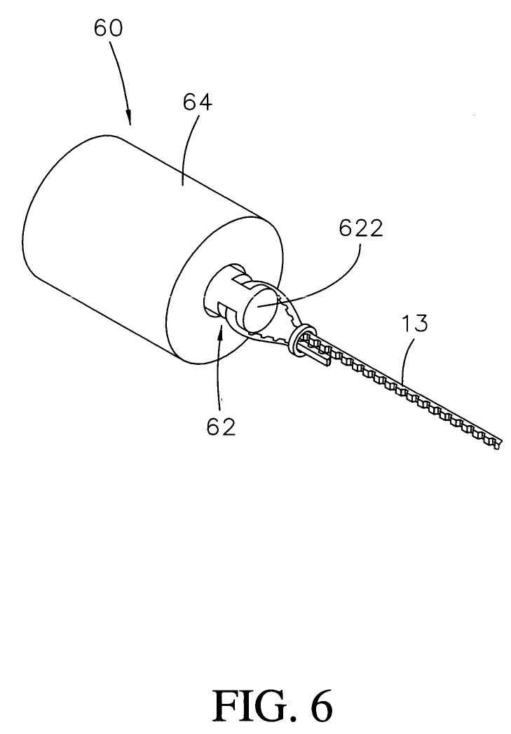

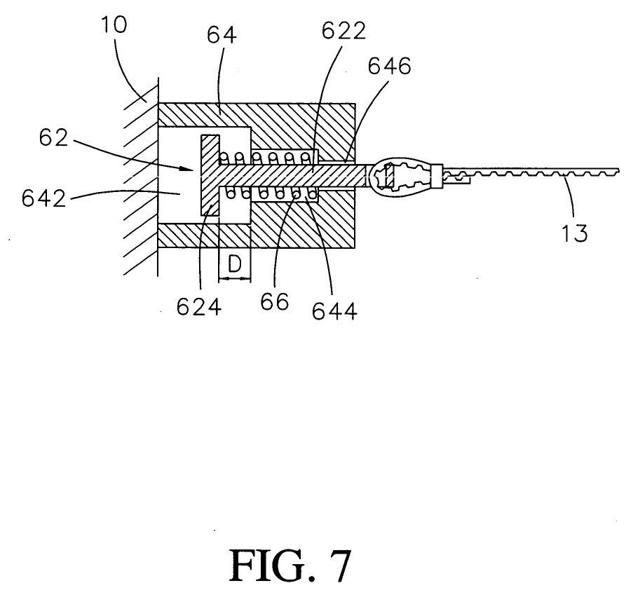

As shown in FIGS. 6 and 7, another embodiment of the present invention has an elastic device 60, comprising a displacement component 62, a fixing component 64, and an elastic component 66.

The displacement component 62 has an axle 622. One end of the axle 622 forms an end part 624 with a larger outer diameter. This configuration makes the displacement component 62 a long T-shaped axle.

The elastic component 66 is a spring or a hollow tubular elastomer, which is disposed around the axle 622 of the displacement component 62.

The fixing component 64 has a hollow tubular structure. The hollow part of the fixing component 64 comprises a first hole chamber 642, which is connected to a second hole chamber 644, which in turn is connected to a third hole chamber 646. The three chambers are formed axially at one end of the fixing component 64. The first hole chamber 642 has the largest diameter, followed by the second hole chamber 644 and the third hole chamber 646. The fixing component 64 is fixed on the wall surface of the casing 10 via the outer end face of the first hole chamber 642.

The displacement component 62 and the elastic component 66 are combined and mounted in the fixing component 64. The axle 622 of the displacement component 62 extends into the first hole chamber 642 and out of the third hole chamber 646. The part of the axle 622 that protrudes out of the third hole chamber 646 is joined with the transmission belt 13. One end of the elastic component 66 rests against the end part 624 of the displacement component 62, while the other end of the elastic component 66 rests against the joint surface of the second hole chamber 644 and the third hole chamber 646. When the assembly is completed and no force is imposed, there is a gap between the end part 624 of the displacement component 62 and the opening shared by the first chamber hole 642 and the second chamber hole 644, which forms distance D, the length of which is less than the compression force that results in permanent deformation to the elastic component 66.

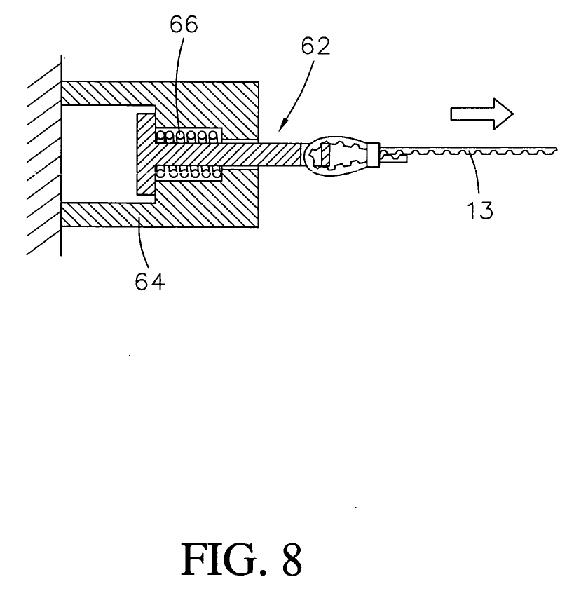

As shown in FIG. 8, the displacement component 62 displaces against the fixing component 64 and the elastic component 66 is compressed when the transmission belt 13 exerts a force on the displacement component 62, Because the displacement of the displacement component 62 is restricted by the distance D, the compression of the elastic component 66 will not bring permanent deformation. This mechanism prevents the deformation of the elastic component 66 due to overload of force and adjusts the tension of the transmission belt 13.

In summary, the design concept of the present invention to protect the elastic component 40 and 66 from deformation due to overload of force involves mounting one end of the elastic component 40 and 66 on the fixing component 50, 64, and the other end on the displacement component 50, 64. A displacement stroke restriction mechanism, such as the corresponding configuration of the displacement hole 32 and the fixing component 50, or the distance D between the end part 624 of the displacement component 62 and the second hole chamber 644, is disposed between the displacement component 30, 62 and the fixing component 50, 64 to restrict the stroke of the displacement component 30, 62. Since the stroke of the displacement component 30, 62 is less than the elastic limit of the elastic component 40, 66, no permanent deformation due to overload of force is brought to the elastic component 40, 66.

According to the present invention, the combination of the displacement component and the fixing component restricts a moving distance of the displacement component, with respect to the fixing component, within a maximum value, the maximum value being less than the maximum extension/compression length of the elastic component.

Although this invention has been disclosed and illustrated with reference to particular embodiments, the principles involved may be applied in numerous other embodiments that will be apparent to persons skilled in the art. This invention is, therefore, to be limited only as indicated by the scope of the appended claims.

What is claimed is:

1. An elastic device mounted in a casing of a scanning device and joined with a transmission belt of a transmission system of said scanning device, comprising:
a fixing component mounted firmly on a surface of said casing;
a displacement component, a first end of which is connected to said fixing component and a second end of which is connected to said transmission belt, wherein said displacement component moves relatively to said fixing component when said transmission belt exerts a force on said displacement component; and
an elastic component for providing a restoring force with a direction opposite to the force exerted by said transmission belt, one end of said elastic component joining with said displacement component, and other end of said elastic component joining with said fixing component;
wherein the combination of said displacement component and said fixing component restricts a moving distance of said displacement component, with respect to said fixing component, within a maximum value, said maximum value being less than the maximum extension/compression length of said elastic component.

2. The elastic device of claim 1, wherein said fixing component is disposed inside an opening of said displacement component.

3. The elastic device of claim 1, wherein said first end of said displacement component is disposed inside a hole chamber of said fixing component, said first end being a distance away from an end surface of said chamber, wherein upon movement of said displacement component, said first end of said displacement component moves toward said end surface.

4. The elastic device of claim 1, wherein said elastic component is a spring.

5. An elastic device mounted in a casing of a scanning device and joined with a transmission belt of a transmission system of said scanning device, comprising:
a fixing component mounted vertically on a bottom surface of said casing;
a displacement component with a rectangular opening located at one end; said opening encircling said fixing component; other end of said displacement component being connected to said transmission belt; said displacement component moves relatively to said fixing component when said transmission belt exerts a force on said displacement component, wherein a distance for which said displacement component travels is limited by a longitude length of said opening; and
an elastic component for providing a restoring force with a direction opposite to the force exerted by said transmission belt, an end of said elastic component connected to said fixing component and other end connected to said displacement component.

6. The elastic device of claim 5, wherein said displacement component is a rectangular plate.

7. The elastic device of claim 5, wherein said displacement component has a hook piece on one end for connecting to said elastic component.

8. An elastic device mounted in a casing of a scanning device and joined with a transmission belt of a transmission system of said scanning device, comprising:
a fixing component mounted firmly on a side wall of said casing and having an hole chamber extending axially through said fixing component with a stepped structure;
a displacement component, with a first end connected to said transmission belt and positioned outside said hole chamber, and with a second end forming an end part and disposed inside said hole chamber, said end part being a distance away from an end surface of the hole chamber, wherein said displacement component moves relatively to said fixing component when said transmission belt exerts a force on said displacement component; and
an elastic component for providing a restoring force with a direction opposite to the force exerted by said transmission belt, said elastic component axially disposed on said displacement component and inside said hole chamber between said end part and said end surface, wherein upon the movement of said displacement component, said end part moves toward said end surface of said hole chamber.

9. The elastic device of claim 8, wherein said hole chamber of said fixing component has sequentially a first hole chamber, a second hole chamber and a third hole chamber; said first hole chamber having the largest diameter, said second hole chamber having the second largest diameter, and said third hole chamber having the smallest diameter; said first end of said displacement component being positioned outside the third hole chamber.

10. The elastic device of claim 9, wherein said end part has an outer diameter smaller than said diameter of said first hole chamber and larger than said diameter of said second hole chamber, wherein said end part is disposed inside said first hole chamber.
